(19) United States
(12) Patent Application Publication
(10) Pub. No.: US 2023/0118533 A1
(43) Pub. Date: Apr. 20, 2023

(54) PROGRESSIVE VISIBILITY IN A SOCIAL NETWORK

(71) Applicant: AMI Holdings Limited, Hamilton (BM)

(72) Inventor: Ronen Benchetrit, London (GB)

(21) Appl. No.: 17/966,162

(22) Filed: Oct. 14, 2022

Related U.S. Application Data
(60) Provisional application No. 63/256,853, filed on Oct. 18, 2021.

(51) Int. Cl. G06Q 50/00

(52) U.S. Cl. CPC G06Q 50/01

(57) ABSTRACT

A potential match is identified between a first user and a second user. A first profile of the first user is configured in a first mode having a first visibility. The first profile of the first user, configured in the first mode, is provided to a second client device associated with the second user. A reconfiguration of the first profile of the first user to a second mode is received from the first client device. The first profile in the second mode has a second visibility that is higher than the first visibility. In response to receiving the reconfiguration, activation of an element is enabled on the first client device. The element is configured to be used on the first client device to establish a match between the first user and the second user.

### CLAIM OF PRIORITY

This application claims priority under 35 USC § 119(e) to U.S. Patent Application Ser. No. 63/256,853, filed on Oct. 18, 2021, the entire contents of which are hereby incorporated by reference.

### FIELD OF THE DISCLOSURE

The present disclosure relates to social networks.

### BACKGROUND

Social networks facilitate interactions between users in various contexts, such as dating, professional recruiting and networking, and interest-based discussion.

### SUMMARY

Some aspects of this disclosure describe a computer-implemented method, which can, in some implementations, be implemented by instructions stored on computer-readable media and/or by computer systems. In the method, a potential match is identified between a first user and a second user. A first profile of the first user is configured in a first mode having a first visibility. The first profile of the first user, configured in the first mode, is provided to a second client device associated with the second user. An indication of approval of the first user is received from the second client device. A notification of the indication of approval is provided to a first client device associated with the first user. A reconfiguration of the first profile of the first user to a second mode is received from the first client device. The first profile in the second mode has a second visibility that is higher than the first visibility. In response to receiving the reconfiguration, activation of an element is enabled on the first client device. The element is configured to be used on the first client device to establish a match between the first user and the second user.

Implementations of this and other methods can have any one or more of at least the following characteristics.

In some implementations, the method includes enabling activation of the element includes querying a database storing a plurality of elements. Each element of the plurality of elements is associated with one or more visibility modes. The querying includes selecting, from the plurality of elements, a subset of elements that are associated with the second mode. The subset of elements includes the element.

In some implementations, the element is associated with the second mode and not associated with the first mode.

In some implementations, the element includes at least one of a user interface element or a response to a user input trigger.

In some implementations, the method includes preventing establishment of the match between the first user and the second user until the first profile is reconfigured from the first mode to the second mode or to another mode with a higher visibility than the first mode.

In some implementations, the reconfiguration of the first profile to the second mode is with respect to the second user, and the method includes, subsequent to receiving the reconfiguration of the first profile to the second mode, providing, to a third user-device associated with a third user, the first profile of the first user configured in the first mode.

In some implementations, the reconfiguration of the first profile to the second mode is a global reconfiguration, and the method includes, subsequent to receiving the reconfiguration of the first profile to the second mode, providing, to a third user-device associated with a third user, the first profile of the first user configured in the second mode.

In some implementations, the method includes, prior to receiving the indication of approval of the first user, receiving, from the second client device, a reconfiguration of a second profile of the second user to have an increased visibility; and, in response to receiving the reconfiguration of the second profile of the second user, providing, to the second client device, a user-interactive interface configured to be used to provide the indication of approval of the first user.

In some implementations, the method includes preventing provision of the indication of approval of the first user until the second profile is reconfigured to have the increased visibility.

In some implementations, the method includes receiving, from the first client device, a second reconfiguration of the first profile of the first user from the second mode to a third mode. The first profile in the third mode has a third visibility that is higher than the second visibility.

In some implementations, the second visibility is higher than the first visibility with respect to photo blurring or video blurring of one or more elements of the first profile.

In some implementations, the second visibility is higher than the first visibility with respect to audio distortion of one or more elements of the first profile.

In some implementations, the second visibility is higher than the first visibility with respect to private information of the first user.

In some implementations, receiving the reconfiguration of the first profile includes receiving an indication of a tap-and-hold on the first client device.

In some implementations, the method includes determining, based on a configuration of the second mode, a first media communication type that is allowed in the second mode, and a second media communication type that is disallowed in the second mode; and providing, to the second client device, a communication interface including a first interface element configured to be used to transmit a message of the first media communication type, the communication interface excluding a second interface element configured to be used to transmit a message of the second media communication type.

In some implementations, providing the first profile of the first user configured in the first mode includes obtaining an image included in the first profile or a video frame included in the first profile; blurring the image or the video frame, to obtain a blurred image or a blurred video frame; and providing the blurred image or the blurred video frame.

In some implementations, a livestream associated with the first user is not visible to the second user when the first profile is configured in the first mode, and the livestream is visible to the second user when the first profile is configured in the second mode.

Some aspects of this disclosure describe another computer-implemented method, which can, in some implementations, be implemented by instructions stored on computer-readable media and/or by computer systems. In the method, a machine learning model is trained using sample data including visibility mode decisions made by a plurality of users of a social network. Data characterizing a relationship between a first user and a second user is input into the machine learning model. As an output of the machine learning model, a recommendation is obtained that the first user modify a visibility mode with respect to the second user. On a first client device associated with the first user, activation of an element is enabled. The element is configured to be used on the first client device to modify the visibility mode.

Implementations of this and other methods can have any one or more of at least the following characteristics.

In some implementations, training the machine learning model includes training a neural network that includes connected nodes. The connected nodes are aggregated into multiple layers, and the connected nodes perform successive transformations of input data.

In some implementations, the sample data includes one or more of: past negative interactions between the plurality of users, lengths of past relationships of the plurality of users, and results of the past relationships of the plurality of users.

In some implementations, training the machine learning model includes weighting sample data associated with the first user more highly than sample data associated with other users of the plurality of users.

In some implementations, the data characterizing the relationship includes one or more of: one or more types of interactions between the first user and the second user; a quality of the interactions between the first user and the second user; interest in the relationship from the first user, the second user, or both the first user and the second user; or a length of the relationship.

Implementations according to this disclosure can realize various advantages. For example, in some implementations, digital communication mechanisms and interactions, such as internet communication channels and transfers of certain media types, are linked to user-configurable visibility settings, which can improve social matching/interaction efficiency and reduce use of computational resources. In some implementations, element provision is linked to visibility settings, such that network transmission burdens are reduced. In some implementations, the technology of inter-user interaction controls in online social networks is improved by the disclosed processes. In some implementations, machine learning models (such as neural networks) are trained to provide recommendations and evaluations.

The details of one or more implementations are set forth in the accompanying drawings and the description below. Other aspects, features and advantages will be apparent from the description and drawings, and from the claims.

### BRIEF DESCRIPTION OF THE DRAWINGS

FIGS. 1A-1C illustrate example user profiles.

FIG. 2 illustrates an example social network.

FIGS. 3A-3F illustrate example user interfaces and user interaction.

FIGS. 4A-4B illustrate example user interfaces and user interaction.

FIGS. 5A-5B illustrate example model training and operation.

FIG. 5C illustrates an example user interface.

FIG. 6 illustrates example allowed and disallowed matching operations.

FIG. 7 illustrates example visibility mode reconfiguration.

FIG. 8 illustrates example element query and provision.

FIG. 9-10 illustrate example processes.

### DETAILED DESCRIPTION

This disclosure relates to social networks that include progressive visibility settings. Users can restrict visibility of their content (such as profile pages, posts, and media items) in customizable ways to provide privacy and security to the user experience. Visibility selections are also tied into allowed or disallowed operations within the social network, such as inter-user matching operations, which can provide a more controlled, secure, and enjoyable user experience. The resulting inter-user interactions may be more efficient and effective, reducing necessary network and processor resource usage.

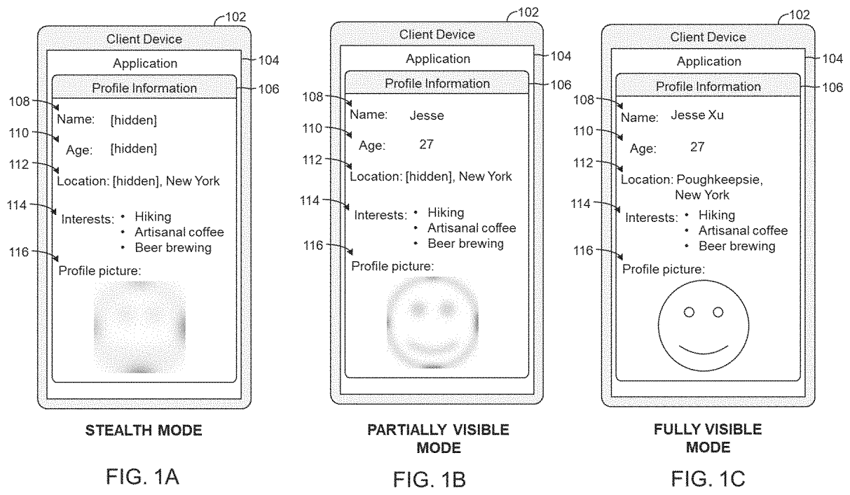

FIGS. 1A-1C illustrate an example profile 106 of a user of a social network application 104 of a social network, as displayed on a client device 102. The profile 106 includes various forms of information about the user, including their name 108, their age 110, their location 112, their interests 114, and their profile picture 116. Profiles may instead or additionally include other information, as described throughout this disclosure.

The profile 106 is shown as it would be presented to one or more other users of the social network in each of three visibility modes: in “stealth mode” in FIG. 1A, in “partially visible mode” in FIG. 1B, and in “fully visible mode” in FIG. 1C. Visibility modes may be configured by the user globally (e.g., to set profile visibility for all other users of the social network), by groups of users as described in more detail below, and/or on a user-by-user basis, such that, for example, a second user sees the profile 106 in stealth mode while a third user sees the profile 106 in partially visible mode. The visibility modes correspond to more or less profile information being presented to other users.

As shown in FIGS. 1A-1C, the name 108 is entirely hidden in stealth mode; only a first name is shown in partially visible mode; and the entire name 108 is shown in fully visible mode. The age 110 is shown only in partially visible and fully visible modes. The location 112 is partially visible in stealth mode and partially visible mode, with only a state of residence shown (alternatively, only the country of residence could be shown in these modes). In the fully visible mode, the city of residence is also shown. Interests 114 are fully visible in each mode. The profile picture 116 is unblurred in fully visible mode and blurred progressively more in the more restrictive visibility modes. These field-specific visibilities are merely examples, and other visibility configurations are also within the scope of this disclosure. For example, in some implementations, a first subset of interests is hidden in the stealth mode while a second subset of interests is visible.

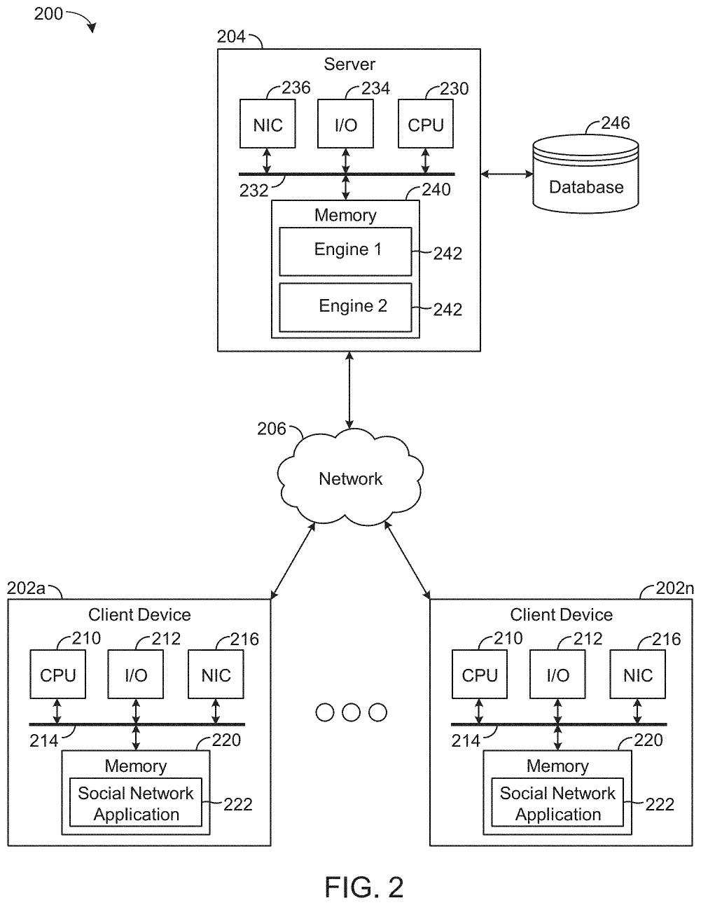

These and other visibility modes help to determine inter-user interactions in the social network. FIG. 2 illustrates a system 200 for interactions in a social network that includes progressive visibility settings. The system 200 includes a plurality of client devices 202a through 202n in communication with a server 204 (which may represent multiple servers and/or other computer systems in communication with one another) via a network 206, which may be a wired or wireless network or any combination thereof. Each client device 202a through 202n (referred to collectively as client devices 202) includes one or more processors (e.g., central processing unit) 210 in communication with input/output devices 212 via a bus 214. The input/output devices 212 can include a touch display, keyboard, mouse, and the like. A network interface circuit 216 is also connected to the bus 214 to provide wired and/or wireless connectivity to the network 206. A memory or other storage medium 220 is also connected to the bus 214. The memory 220 stores instructions executed by the processor 210. In particular, the memory 220 stores instructions for a social network application 222, such as a dating application, which communicates with server 204 to coordinate interactions between users. In some implementations, each client device 202 is a mobile device (e.g., smartphone, laptop, tablet, wearable device, etc.) executing the social network application 222. Different client devices 202 are operated by different users that subscribe to the same social network application 222.

The server 204 includes one or more processors 230, bus 232, input/output devices 234 and a network interface circuit 236 to provide connectivity to the network 206. A memory 240 is connected to the bus 232. The memory 240 stores one or more engines 242 with instructions executed by the processor 230 to implement operations. In some implementations, the system 200 includes one or more databases 246 in communication with the server 204, the one or more databases 246 storing information for use by the social network application 222 and/or the engines 242, user profile information, match information, message information, visibility mode information, and/or other information.

Various types of social network are within the scope of this disclosure. In some implementations, the social network is a dating network. For example, the social network may include user profiles and allow users to match with one another in a user-directed fashion (e.g., by swipe-based approval or disapproval), in an automated fashion (e.g., by automatic matching of compatible users), or in a combination of these ways. In some implementations, the social network is a social network that includes non-dating matching and interaction. For example, the social network may include matching and discussions based around topics of common interest, such as politics and hobbies. The social network may be a “friend”-focused network in which non-romantic matching is included or emphasized. In some implementations, the social network is a professional network that connects workers with one another and with businesses, e.g., by employee-hirer matching. Workers can list their work history, qualifications, and professional interests, recommend one another for open job positions, be recruited by interested companies, and share interesting commercial articles and comments. These and other social network types can also be combined together. For example, one social network may include both dating and non-dating interaction options, while another social network may combine professional networking with hobby-focused discussions.

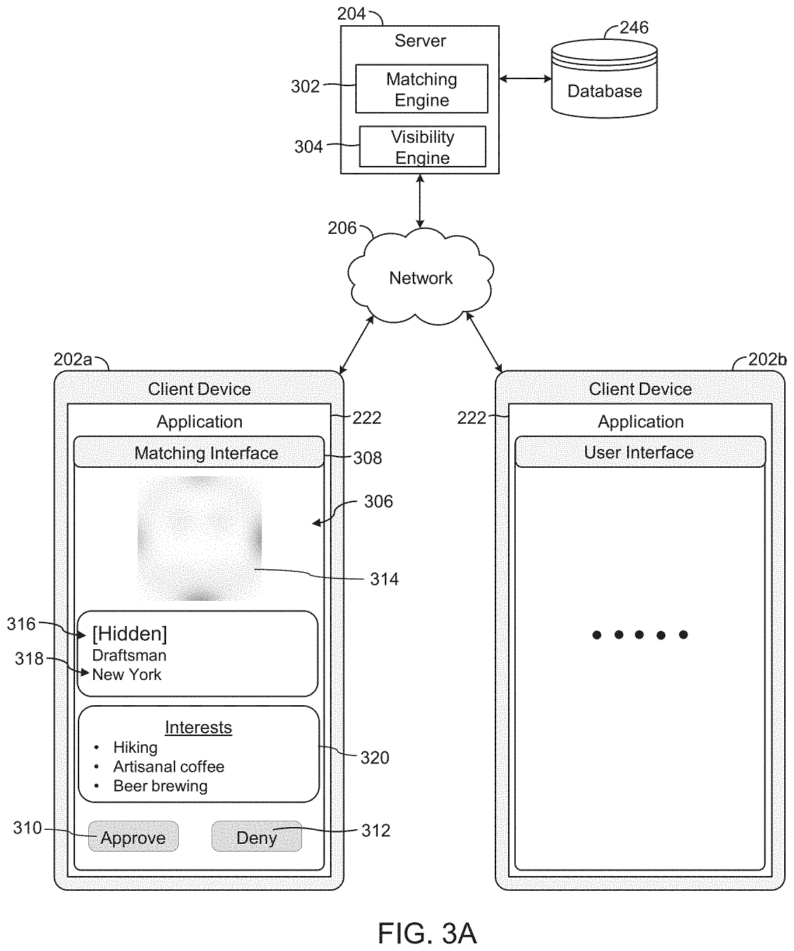

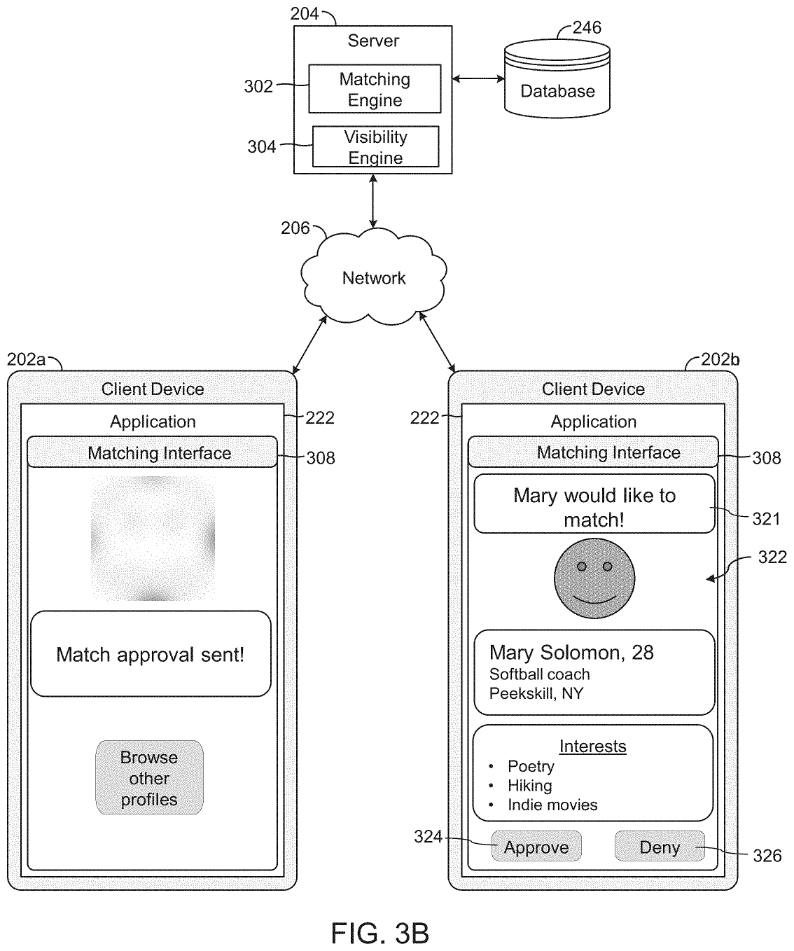

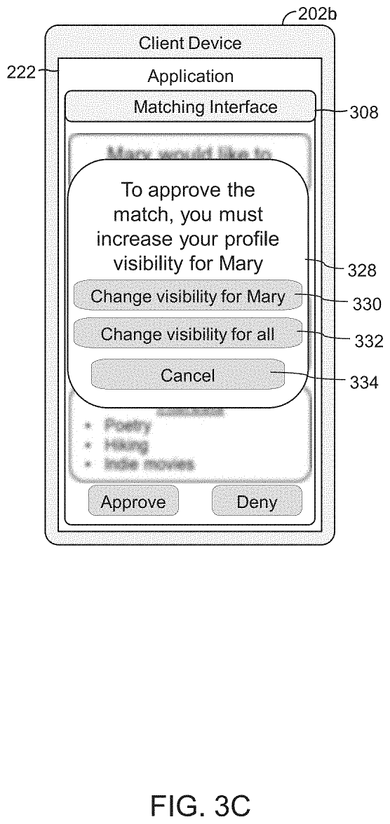

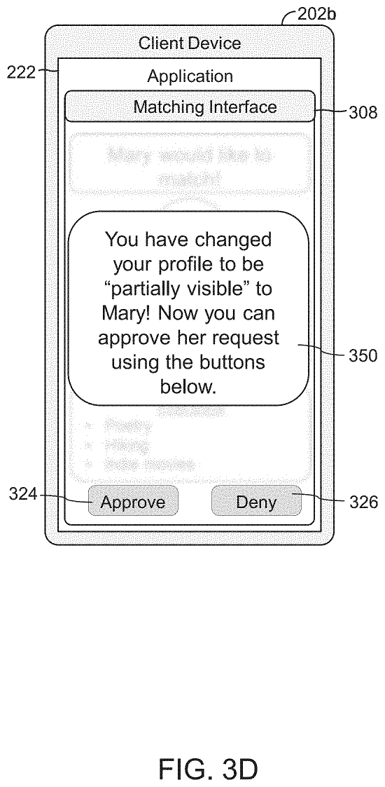

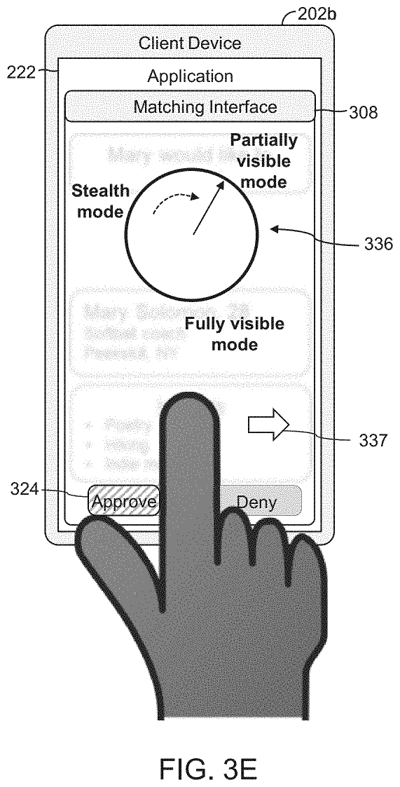

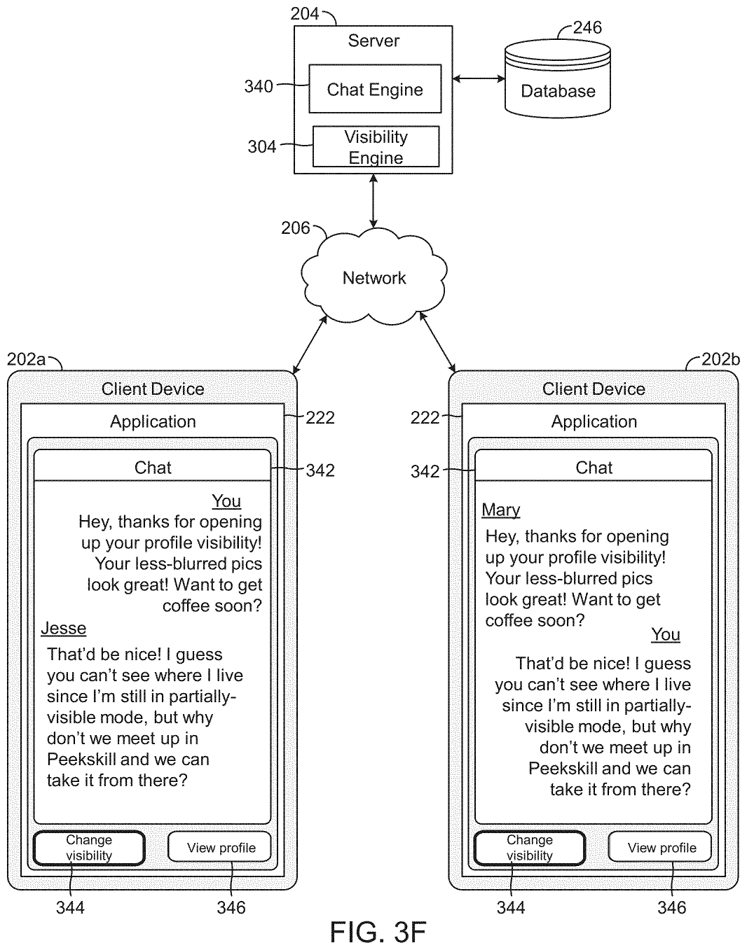

In some implementations, progressive visibility settings determine outcomes of matching-related operations. For example, certain visibility settings may be prerequisites for certain matching operations. FIGS. 3A-3F show such an example of matching between users of the social network in the context of progressive visibility settings. As shown in FIG. 3A, a first user associated with a first client device 202a is presented with a profile 306 of a second user associated with a second client device 202b. For example, a server-side matching engine 302 may suggest the match to the first user based on compatible profile information of the two users. The profile 306 is presented in a matching interface 308 that includes respective invocable interface elements 310, 312 by which the first user may approve or deny a match with the second user. A visibility engine 304 of server 204 regulates element provision or activation based on visibility modes selected by either or both of the first user and the second user. Other types of interface elements may also be used to perform operations within the social network application 222. For example, match approval/disapproval may be expressed through swipe based operations, e.g., “swiping left” or “swiping right.”

In the example of FIG. 3A, the second user has elected to set their profile 306 in stealth mode with respect to the first user. For example, stealth mode may be set by the second user as a default configuration in which the profile 306 is to be presented to other users in the absence of a configuration by the second user to present the profile 306 in a non-stealth mode to a particular user. Because the profile 306 is set to stealth mode with respect to the first user, various content of the profile 306 (corresponding to the second user) is hidden or obscured as displayed in the matching interface 308 on the first client device 202a. The profile picture 314 of the second user is significantly blurred, the name 316 of the second user is hidden, and the location 318 of the second user is given only generally as “New York.” In this example, interests 320 are revealed even in stealth mode. In a match-based social network such as a dating network, it may be desirable to make some profile elements visible across all visibility modes, to provide some basis by which users can judge one another for compatibility. Interests and introduction messages (e.g., “here is what I'm looking for from a match . . . ”) are well-suited to this role because they can generally be fully revealed without exposing personally-identifying information or private information.

In this example, the first user selects the “approve” interface element 310, e.g., based on a mutual interest in artisanal coffee. At this point, as shown in FIG. 3B, the second user is presented with a notification 321 of the match approval and can view a profile 322 of the first user on the second client device 202b. The profile 322 of the first user may be presented in one of several forms. In some implementations, the profile 322 is presented with a visibility that matches a current visibility of the profile 306 of the second user—in this case, stealth mode. For example, the second user is presented with profile information matching what the second user has themselves elected to reveal to others at initial stages of the matching processes. The profile 322 may be displayed with that matching visibility even if the first user has set another visibility mode (e.g., partially visible) as their default visibility mode. This configuration may incentivize users to select higher-visibility visibility modes, because users will be restricting not only what they reveal but also what they are able to view in potential matches.

In some implementations, the profile 322 of the first user is presented on the second client device 202b in a visibility mode selected by the first user, e.g., without regard for the visibility mode selected by the second user (in this example, stealth mode). For example, the profile 322 may be presented in partially visible mode or fully visible mode depending on configuration by the first user. In the example of FIG. 3B, the profile 322 of the first user is presented in a higher visibility mode than the stealth mode in which the profile 306 of the second user was presented to the first user in FIG. 3A. For example, a full name and detailed location of the first user are visible to the second user.

In some implementations, though, the initial selection by the first user to initiate or approve a match with the second user is conditional on a visibility state of the first user's profile. For example, the first user may be prevented (by appropriate provision of visibility-associated elements, as described in further detail below) from selecting the “approve” interface element 310 while the first user's profile 322 is configured in stealth mode with respect to the second user. This can help the second user make an informed matching decision for the first user, because more information about the first user will be provided to the second user when the first user approves the match. When the first user tries to approve the match with the second user, the first user may be provided with a prompt or notification suggesting a change to the profile mode of the profile 322 in order to make the match, e.g., as described for the second user in reference to FIGS. 3C-3E.

In addition to the notification 321 the second user is presented with interface elements 324, 326 by which the second user can approve or deny the match with the first user. In some implementations, the approval or denial can be made regardless of a profile visibility setting of the second user. For example, in some implementations the second user may approve the match and initiate match-related operations (e.g., chatting) while remaining in stealth mode with respect to the first user.

However, in some implementations, the second user is not permitted to approve the match with the first user until the second user has reconfigured their profile 306 to be more visible, e.g., increased the visibility mode from stealth mode to partially visible mode or fully visible mode. This restriction may take one or more of various forms. For example, in some implementations, when the second user selects the “approve” interface element 324, a notification 328 is presented on the second client device 202b as shown in FIG. 3C. The notification 328 informs the second user that they cannot approve the match while their profile 306 is in stealth mode with respect to the first user. User interface elements 330, 332, 334 are provided by which the second user may, respectively, switch to a different visibility mode with respect to the first user (e.g., while remaining in stealth mode for other users by default), switch to a different default visibility mode with respect to all other users, including for the first user, or elect to not approve the match and remain in their current visibility mode. After the second user has reconfigured their visibility mode with respect to the first user, a further notification 350 is provided on the second client device 202b, indicating to the second user that the interface element 324 is now usable to approve the match with the first user, as shown in FIG. 3D. In some implementations, selection of user interface elements that reconfigure the visibility mode, such as user interface elements 330, 332, also approves the match.

Other visibility mode-configuration methods may instead or additionally be used. For example, in some implementations the “approve” interface element 324 is indicated as non-selectable (e.g., grayed out). As shown in FIG. 3E, the second user may tap-and-hold on a region of the matching interface 308 on the second client device 202b (e.g., on the first user's profile 322) and, in response, the second user's visibility mode is toggled from stealth mode to partially visible mode. Continued holding will toggle the visibility mode from partially visible mode to fully visible mode, after which further holding will toggle the visibility mode from fully visible mode back to stealth mode. Each reconfiguration may occur after a hold for a predetermined amount of time, e.g., three seconds. An indicator such as the example cyclical graphic indicator 336 may be included to show these changes.

In some implementations, tap-and-hold-based visibility mode reconfiguration is combined with swipe-based approval functionality. The second user may tap the first user's profile, hold the tap until the visibility mode has been reconfigured as desired, and then seamlessly transform the hold into an affirmative swipe (e.g., a rightward swipe), as indicated by arrow 337. This can provide an improved user experience, e.g., by integrating visibility settings (with which a user may be relatively unfamiliar) into the more common operation of swipe-based approval/disapproval.

Subsequent to the change in the visibility mode and acceptance of the match by the second user, various inter-user interactions may be facilitated by the social network application 222. For example, a communication channel such as chat, voice, or video may be opened between the first user and the second user. As shown in FIG. 3F, chatting is provided between the first user and the second user. In some implementations, the chatting is provided conditional on the match being approved by the second user, which is itself conditional on the second user reconfiguring their profile into a higher visibility mode. Chatting is facilitated by a chat engine 340 of the server 204. Besides text functionalities, a chat interface 342 may include interface elements 344, 346 by which the users can change their visibility settings or view the profile of the other user. In this example, if the first user selects interface element 346 to view the profile 306 of the second user, the profile 306 is presented in a higher visibility mode than the stealth mode profile initially shown to the first user (e.g., as shown in FIG. 3A). For example, the profile 306 may be presented as shown in FIG. 1B or FIG. 1C.

In some implementations, instead of or in addition to global or user-specific visibility mode settings, visibility mode can be set for one or more groups of users. Visibility modes may be set with respect to groups of users with particular characteristics. For example, a higher visibility mode can be set for users having at least a threshold similarity, e.g., similarity as measured by similarity in age, interests, location, and/or other characteristics, such that similar users can view more profile information (and/or perform more interaction operations) than dissimilar users. In some implementations, visibility modes may be set based on location, such that, for example, closer users are by default set to a higher visibility mode than farther users, or vice-versa.

FIGS. 3A-3F show various ways in which progressive visibility settings may be integrated into user matching operations and profile viewing operations. However, in some implementations, progressive visibility settings instead or additionally structure inter-user interactions after initial matching, e.g., during continued chatting and dating portions of a relationship cycle.

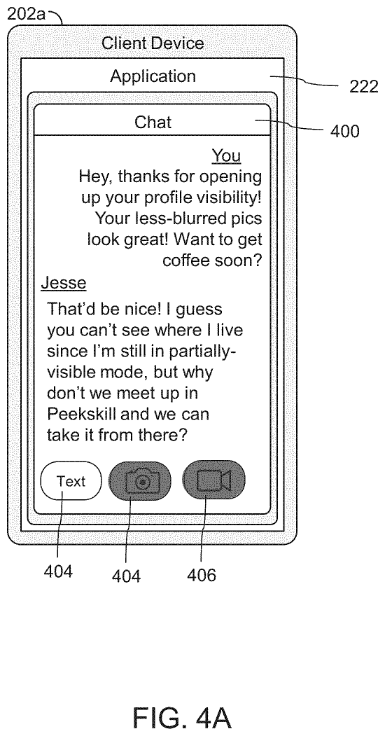

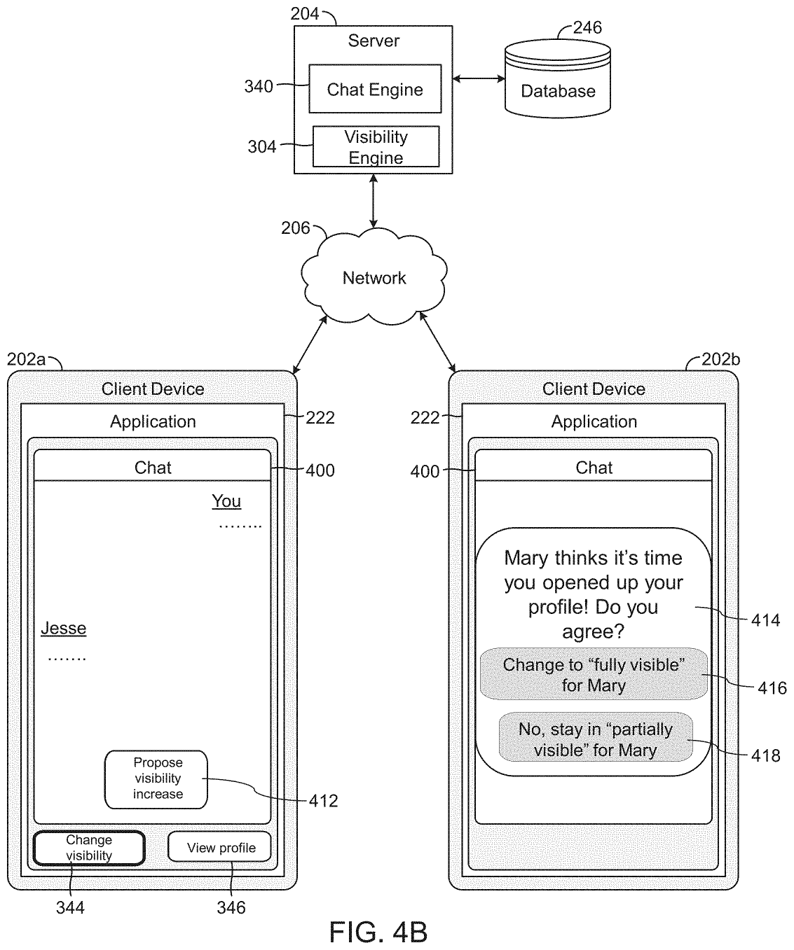

For example, as shown in FIG. 4A, in some implementations certain user interactions are locked behind higher visibility modes, even after two users have agreed to a match. In the example chat interface 400, a texting interface element 402 is enabled to allow texting between two users. However, an image transmission interface element 404 is disabled (or simply not shown), e.g., by graying out the image transmission interface element 404 or presenting the image transmission interface element 404 in a crossed-out manner. A videochat interface element 406 is also disabled or not shown. Image transmission and videochat operations are locked behind a higher visibility mode being selected by one or both of the users. The locking of these operations and other operations/interactions may be mutual (e.g., disabled for both users even if only one of the users has their profile configured in a visibility mode that does not support these operations) or may be performed on a per-user basis (e.g., if the first user is in fully visible mode while the second user is in partially visible mode, the second user can send images to the first user but the first user cannot send images to the second user). Interaction controls such as these may improve user comfort, e.g., by decreasing the likelihood that a user will receive undesired inappropriate images. In this and other examples, communications are allowed or disallowed based on a media type of the communications, e.g., text transmission compared to image transmission compared to video transmission.

In some implementations, users are provided with the ability to suggest visibility mode changes during inter-user interactions. For example, as shown in FIG. 4B, a chat interface 400 includes an interface element 412 by which the first user can request that the second user increase their visibility with respect to the first user. When the interface element 412 is selected, the second user is provided with a notification 414 suggesting the change, along with interface elements 416, 418 by which the second user can approve or disapprove the requested change. Other interface interaction methods may instead or additionally be used, e.g., tapping-and-holding in the chat interface 400.

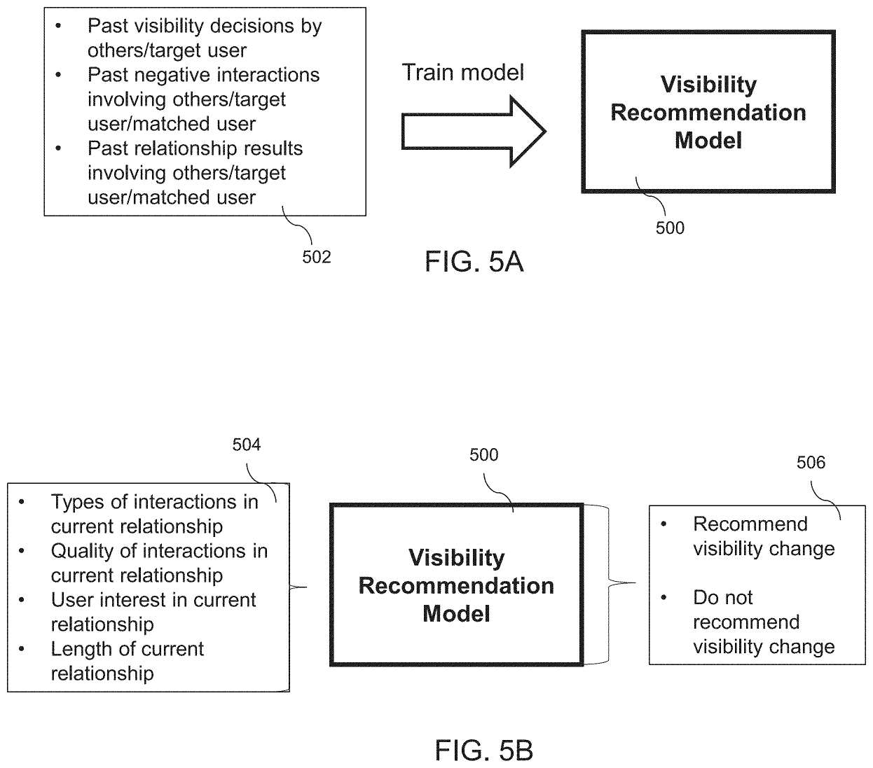

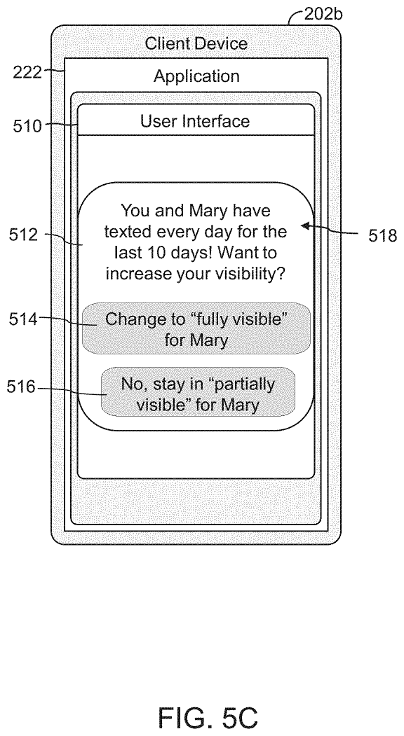

In some implementations, the social network itself automatically recommends changes to visibility settings. The visibility engine 304 may be configured to track users' interactions and determine, for example, when a relationship has progressed to the point that a further increase in visibility would be appropriate. As shown in FIG. 5A, a visibility recommendation model 500 (e.g., included in the visibility engine 304) can be trained to recommend that a target user increase their visibility with respect to a second user (“matched user”) with whom the target user is matched. The visibility recommendation model 500 is trained based on sample data 502 characterizing past interactions between users in the social network. Training the visibility recommendation model 500 may include performing unsupervised learning and/or supervised learning. In some implementations, the visibility recommendation model 500 includes a neural network in which connected nodes, aggregated into multiple layers, perform successive transformations of input data.

Non-limiting examples of sample data include the following: past visibility decisions made by users (e.g., decisions to configure a higher visibility mode or a lower visibility mode, and/or decisions not to change a visibility mode, such as in response to requests by other users or suggestions by the social network); past negative interactions between users; and results of past relationships, e.g., how long the relationships continued, whether the relationships progressed to in-person meetings, etc. These data types and other data types can be used to train the visibility recommendation model 500 to learn what timings of visibility mode changes are conducive to positive relationships, what timings of visibility mode recommendations are more or less likely to be approved by a target user, how a visibility mode recommendation can be timed to decrease the likelihood of negative interactions that exploit increased profile visibility, etc. In some implementations, the visibility recommendation model 500 is a general model used generically for many users of the social network. In some implementations, the visibility recommendation model 500 is a personalized model that is trained specifically for the target user, the matched user, and/or the specific combination of the target user and the matched user. For example, data corresponding to the target user and/or the matched user may be given higher weighting during model training to make the visibility recommendation model 500 personalized.

As shown in FIG. 5B, input data 504 of a current relationship between the target user and the matched user is input into the visibility recommendation model 500. Non-limiting examples of input data 504 include types of interactions that have so far taken place in the current relationship (e.g., texting, videochatting, in-person meetups, and other interactions types); a quality of interactions in the current relationship (e.g., as determined by direct user feedback and/or natural language processing-derived valence/sentiment analysis of user texting, audiochats, and/or videochats); user interest in the current relationship (e.g., as determined by a frequency of interaction and/or a frequency of checking the profile of the other user); and/or a length of the current relationship. Note that each of these and other types of data used as input data 504 can have corresponding past data of the same type, corresponding to the same and/or other users, included in the sample data 502 used to train the visibility recommendation model 500.

The visibility recommendation model 500 uses the input data 504 to produce an output decision 506. For example, the output decision 506 may include: recommending a visibility change to the target user; providing, to the matched user, the option to request a visibility change from the target user; or not recommending a visibility change. The recommended visibility change is usually an increase in visibility in order to facilitate closer interactions. However, in some cases the visibility recommendation model 500 can recommend a decrease in visibility mode, such as if data of the matched user suggests that the matched user may abuse private information of the target user. In some implementations, an option for the matched user to request a visibility change (e.g., the interface element 412) does not appear until a visibility recommendation model 500 has determined that the visibility mode change would be appropriate/recommended.

As shown in FIG. 5C, in a user interface 510, an example recommendation 512 to a target user includes selectable user interface elements 514, 516 by which the user may approve or decline a suggested visibility mode change. In some implementations, the recommendation 512 includes relationship-characterizing data 518 that motivates the proposed change.

As noted in reference to FIGS. 3A-3F, in some implementations match approval operations (including either or both of initial match request operations from a first user and confirmatory match approval operations by a second user) are permitted only if a compatible combination of visibility modes have been configured by the two users. An unpermitted match approval operation may be indicated by a missing or unselectable user interface element (e.g., a grayed-out or crossed-out user interface element), a failure notification presented when a user attempts to perform the operation (the failure notification including, in some implementations, an option to reconfigure a visibility mode to allow the match approval operation to proceed), and/or a general notification that is presented to the user (e.g., upon the user opening the social network application 222).

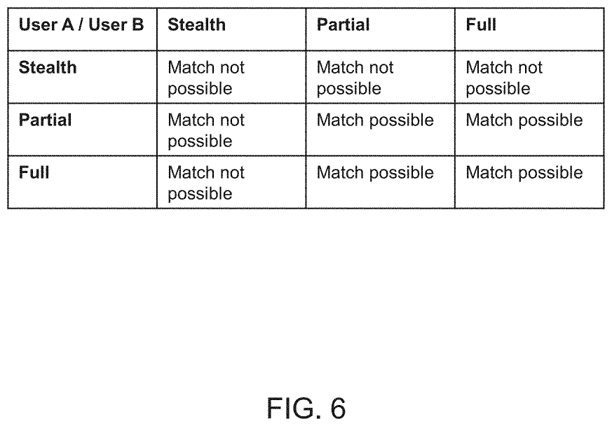

FIG. 6 shows an example of how visibility modes can structure allowed matches, for an example social network with three visibility modes. When two users, User A and User B, are both in stealth mode, a match is “not possible” between them. A match being “not possible” may mean that neither user may submit a match request to the other user while the requesting user is in stealth mode, or may mean that a requested match cannot be accepted while the accepting user (who received the request) is in stealth mode, or both, depending on the implementation. When a first user is in stealth mode and a second user is in partially visible mode, a match is not possible between them. When a first user is in stealth mode and a second user is in fully visible mode, a match is not possible between them. Matches are possible between two users in partially visible mode, two users in fully visible mode, or two users of whom one is in partially visible mode and one is in fully visible mode. In this example, accordingly, matching operations are gated based strictly on the stealth mode configuration, such that a user in stealth mode has some matching operations not permitted to them. However, even in this example, as noted above, other types of operations and interactions may be gated based on partially visible mode or fully visible mode, such as certain communication types and the visibility or presentation of certain profile elements.

Although this example configuration, and other example configurations throughout this disclosure, refer to three distinct visibility types, implementations according to this disclosure may include two, four, or more visibility modes. For example, there may be intermediate visibility modes, e.g., between stealth mode and partially visible mode and/or between partially visible mode and fully visible mode, these intermediate visibility modes being associated with permitted or unpermitted elements/operations as disclosed for the three primary example modes described herein.

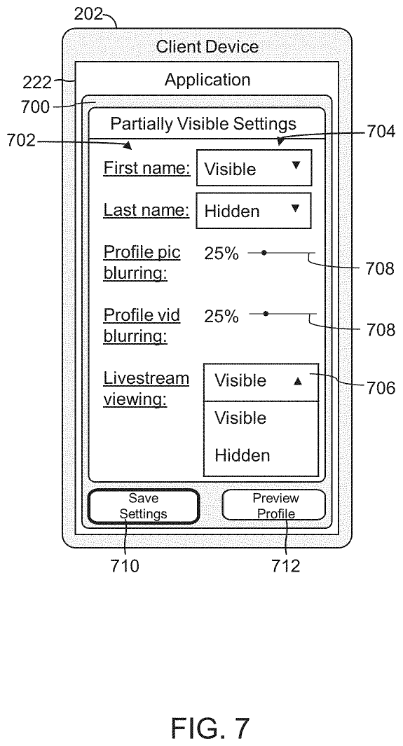

Moreover, in some implementations, users are provided with tools by which the users can configure custom visibility modes. For example, as shown in FIG. 7, a configuration interface 700 includes fields/operations 702 and corresponding visibility selections 704 for the partially visible mode. A user can use this configuration interface 700 to change settings for this mode from their default states. For example, the user may adjust sliders 708 to change blurring values, and a drop-down menu 706 can be manipulated to toggle between discrete visible/hidden states. Here, a first user has reconfigured the “livestream viewing” option from its default “hidden” state (for users for whom the first user is in the partially visible mode) to a “visible” state. Additional interface elements 710, 712 allow the first user to save the reconfigured visibility settings and to preview how their profile will look under the adjusted partially visible mode settings. Analogous tools to those shown in FIG. 7 can allow users to construct new, fully-customized visibility modes.

Other customization features may also be incorporated into implementations of this disclosure. For example, in some implementations users are provided with interfaces by which the users can configure their images for different visibility modes on a per-image basis. For example, a first set of photos may be viewable in stealth mode, a second set of photos may be viewable in stealth mode and partially visible mode, and a third set of photos may be visible across all modes.

A wide variety of profile elements, inter-user interactions, or social media operations can be gated by, or variable based on, visibility modes. Non-limiting examples of these are given below along with example default visible settings for a three-visibility-mode social network. However, as described above, some implementations may include two, four, or more different visibility modes, or a customizable number of visibility modes, and visibility modes may themselves be customizable away from their default settings, such as the example default settings described below.

In some implementations, profile pictures, video profiles, and/or audio profiles are hidden, distorted, and/or blurred based on visibility modes. A video profile or audio profile is an introductory video or audio statement posted by a user to their profile. In some implementations, photo and/or video updates may be instead or additionally presented in sequence, e.g., as a story or timeline. Video and picture blurring may be uniform (e.g., across entire pictures or video frames) or may be smart, targeted blurring, e.g., blurring localized on faces identified by a computer vision algorithm. Similarly, audio distortion may be uniform across an audio transmission or may be smart distortion or transformation of voices based on a voice identification algorithm. Blurring and distortion may be set at 50% in stealth mode (on an arbitrary scale), 25% in partially visible mode, and 0% in fully visible mode.

Besides blurring, in some implementations images, video, and/or audio associated with a user are simply visible or not visible depending on the visibility mode. For example, some or all images may be hidden in stealth mode and visible in partially visible and fully visible modes.

Text communication may be disallowed in stealth mode (e.g., may be conditional on a confirmed match that cannot be confirmed without a user switching out of stealth mode) and allowed in partially visible and fully visible modes.

Image communication (e.g., transmission of photos) may be disallowed in stealth and partially visible modes and allowed in fully visible mode, or may be disallowed in stealth mode and allowed in partially visible and fully visible modes.

Video communication may be disallowed in stealth mode and partially visible modes and allowed in fully visible mode, or may be disallowed in stealth mode and allowed in partially visible and fully visible modes.

First names may be hidden in stealth mode and visible in partially visible and fully visible modes.

Last names may be hidden in stealth and partially visible modes and visible in fully visible mode.

Gender identity may be visible across all visibility modes, or may be hidden in stealth mode and visible in partially visible and fully visible modes.

Age may be hidden in stealth mode and visible in partially visible and fully visible modes.

City may be hidden in stealth and partially visible modes and visible in fully visible mode.

Region (e.g., state, province, or country) may be visible across all visibility modes.

Some profiles may include “badges” that provide helpful information to facilitate matching. Badges can include “looking for” badges (e.g., “hookups,” “friendships,” “long-term relationships”), height badges, star sign badges, drinking and smoking badges, religion badges, politics badges, and other badge types. Badges may be visible across all visibility modes.

Interests may be provided in badge form or as their own category of profile information. Interests may be visible across all visibility modes.

Some social networks may include a livestream feature by which users can stream video and/or audio for live viewing by other users. Livestreams may be hidden in stealth and partially visible modes and visible in fully visible mode.

Story or timeline viewing may be prohibited in stealth and partially visible modes and allowed in fully visible mode, or may be prohibited in stealth mode and allowed in partially visible and fully visible modes.

By incorporating progressive visibility modes into profile viewing and inter-user interactions/operations, social networks can facilitate improved user comfort and willingness to interact with other users. For example, a match decision that otherwise would present high stakes to a deciding user (e.g., because an approval of the match would cause significant personal information to be revealed to the other user) can be made lower stakes by hiding certain profile information until later in a relationship. Gating of media communications (e.g., photo and/or video) by visibility mode can reduce the likelihood of, and user concern regarding, inappropriate or undesired communications between matched users. These positive effects of progressive visibility modes may reduce overall processing and network resources necessary for matching and social network operation, because suggested relationships will, on average, be more likely to be accepted and succeed, such that fewer matching cycles (with corresponding consumption of processing resources) are necessary. And the resulting relationships may then be more likely to progress quickly to an offline stage, e.g., offline dating. This reduces processing resource consumption and network resource consumption that would otherwise be needed for users to continue using online aspects of the social network.

Moreover, many of these processes may be specific to online social networks and online match-based dating/relationship systems, because the interactions and operations controlled by the progressive visibility modes are specific to online social networks and online match-based relationship systems. Progressive visibility systems as described herein accordingly represent an improvement to the technology of inter-user interaction controls in online social networks.

In some implementations, at least some stored data elements (“elements”) of the social network are each associated with one or more visibility modes, e.g., on a per-user basis and/or based on default settings. The elements may include user interface elements such as selectable icons, application features, operations and functions performable by client devices or requestable by client devices to be performed at a remote server, user images, user statistics, protected user data (e.g., user data with restricted view access, such as private information), and/or other data elements. Each element may be stored in a database in association with labels for one or more types of visibility modes for which the element is allowed/disallowed (or visible/hidden, etc., depending on the type of element), in some cases on a per-user basis to allow for customized visibility settings. For example, at least some elements may include “visibility” fields (e.g., in a header or metadata of the elements) by which the visibility settings associated with the elements can be identified. In some implementations, the elements may be associated with object classes that mediate the association between visibility modes and elements, e.g., in a multiple inheritance arrangement. A variety of organizational frameworks for the association of elements with visibility modes are within the scope of this disclosure.

Using these and other data-organizational frameworks in which visibility configurations are built into underlying data elements and relationships between data elements, social network processing efficiency and network resource efficiency can be improved. Interactions between users can be specifically tailored to data and interaction types allowed by their respective visibility modes, such that unnecessary data (e.g., images that are hidden in an applicable visibility mode, application operations beyond the scope of the visibility mode, and user interface elements that correspond to data and operations beyond the scope of the visibility mode) are not transmitted to client devices and/or are not subject to unnecessary resource-consuming processing. For example, elements beyond the scope of a selected visibility mode may be filtered out preliminarily when retrieving data to transmit to a client device. Accordingly, the technologies of social network data organization and social network data provision can be improved.

In some implementations, when a client device associated with a first user requests elements associated with a second user and/or elements relevant to operations/interactions between the first user and the second user, servers of the social network (e.g., server 204) identify by querying, from a pool of elements, a subset of elements that are associated with the respective visibility modes selected by the first user and second user with respect to one another.

In some implementations, the subset of elements includes user interface elements corresponding to operations that fall within the scope of applicable visibility modes. User interface elements to initiate various chats, media transmission, match requests/approvals, and other interactions are associated with visibility modes and/or combinations of visibility modes and are provided to users when those visibility modes have been selected by the users. For example, within a chat interface 342 as shown in FIG. 3F, interface elements selectable to send images/video (not shown) may be provided only when the receiving user is in fully visible mode. These interface elements are stored in association with an indicator of the fully visible mode, and a query to provide the chat interface 342 does not return these image/video interface elements when fully visible mode is not selected.

With respect to match requesting and approval, for example, multiple versions of interface element 324 may be stored as separate elements. A first version is associated with stealth mode and is unselectable (e.g., grayed out) or, when selected, causes a notification to be provided to the user that the user cannot approve the match without increasing their visibility mode, such as the notification 328. A second version is associated with partially visible mode and fully visible mode and is selectable to approve the match. When a query is performed to retrieve elements to be provided to the user, the appropriate version is identified and provided based on the user's visibility mode with respect to a match-requesting user.

In some implementations, such as in a swipe-based match requesting/approval interface, swipe detection and swipe feedback configurations/settings may themselves be elements associated with different visibility modes. These elements can include animations and operations triggered by user inputs. For example, with respect to a user input of a rightward swipe, a triggered first animation and response element is associated with stealth mode. The first animation and response element causes a disallowance animation to be displayed, the disallowance animation including, for example, a swiped profile being reverted back to its default, un-swiped position, and a notification being displayed requesting that the swiping user increase their visibility. A second animation and response element triggered by a user input of a rightward swipe includes a “match approved successfully” notification. The stored associations (in remote and/or local storage) of different animations, responses, notifications, operations, interface elements, and other elements with different visibility mode configurations integrates element query operations, user interface provision, and back-end processing together with progressive visibility modes in the social network.

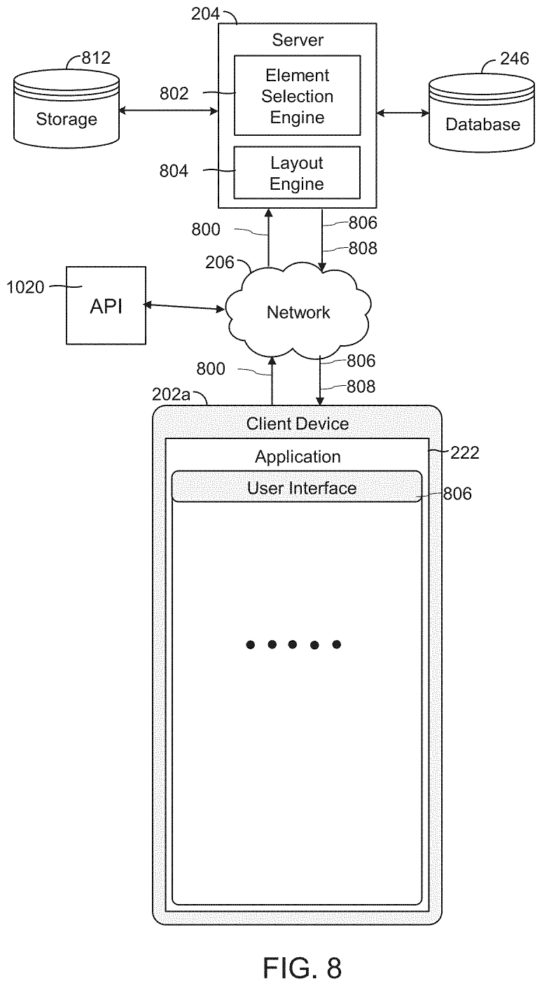

In operation, as shown in FIG. 8, when a client device 202a, associated with a first user, transmits a request 800 to the server 204, a visibility-based element selection engine 802 queries a database 246 to select a subset of elements associated with the visibility modes of the first user, a second user with which the user is interacting, or both. For example, the element selection engine 802 identifies elements that are associated with (e.g., visible in or allowed in) a visibility mode of the second user with respect to the first user. In some implementations, this querying and selection is performed based on one or more discrete rules, e.g., “IF (image_transmission.modes INCLUDES partially_visible) THEN (PROVIDE image_transmission.interface_elements).” Querying and selection may instead or additionally be based on a machine learning approach in which elements are selected in a flexible, dynamic manner. For example, one or more machine learning models may be used to associate each element with a score. Inputs to the machine learning models can include, for example, the visibility modes of the users, data of past interactions between the users, user profile data of the users, or a combination thereof, and/or other data. A subset of the elements is then selected for provision based on the scores. For example, a number of elements having higher scores than other elements can be selected.

When elements have been selected, in some implementations a layout engine 804 combines at least some of the selected user interface elements into a user interface 806 to be transmitted to the client device 202a. In some implementations, selected elements 808 besides the user interface 806 are also or instead transmitted and may be stored locally on the client device 202a until called in the social network application 222 of the client device 202a. For example, images of a user, available because of a selected visibility mode of the user, may be transmitted to the client device 202a and stored in a cache of the client device 202a until needed.

In some implementations, some selected elements that are associated with the relevant visibility mode(s) are not immediately transmitted to the client device 202a but rather are recorded at the server 204 to be called later. For example, these elements may be prepared in a cache or other storage 812 coupled to the server 204 for quick retrieval at a later point in time. In some implementations, a storage structure of the storage 812, server 204, or database 246 is updated to facilitate quick retrieval of the elements. For example, a database index or table index may be updated to reflect the relevant visibility modes of users interacting with one another, such that elements within the scope of the visibility modes can be retrieved more quickly in the future.

The layout engine 804 may use hard-coded layout rules, machine learning algorithms, or a combination thereof to present the selected user interface elements in a manner that preserves user experience. For example, an order and location of a first user interface element may be kept consistent even while one or more other user interface elements are either present or not present in the user interface 806. Performing the element selection and/or user interface generation processes at the server 204 may reduce total network transmission loads, because only the relevant elements are transmitted to the client device 202a: network transmission resources are not wasted on assets that will not be utilized because they are outside the scope of visibility modes. In addition, because elements are effectively filtered at the server 204 before transmission to the client device 202a, the chances of data security violations (e.g., packet interception to obtain elements that are not within the scope of selected visibility mode(s)) may be reduced.

In some implementations, some or all of the operations described herein as being performed at the remote server 204 (e.g., query of the database 246 based on visibility mode, and provision of elements based on results of the querying) can be performed locally on the client devices 202. This can reduce response time for responding to user operations. For example, in some implementations, rather than only a visibility-mode-appropriate element of a given type being provided by the server 204 to the client device 202a, elements of the type suitable to multiple visibility modes are provided in advance and stored in a storage of the client device 202a. For example, profile data encompassing multiple visibility modes can be provided and/or swipe response operations suitable to multiple visibility modes can be provided. When a particular type of element is required (e.g., when a user performs operations such a viewing a profile, chatting with another user, or attempting to match with another user), the multiple elements of that type stored on the client device 202a are queried to identify the particular one or more that are appropriate given the relevant visibility mode of the user and/or relevant visibility mode of another user with which the user is interacting. Information indicating updates to the visibility mode of the other user may be received at the client device 202a from the server 204 to allow the client device 202a to locally enable or disable elements, and/or provide elements, based on an up-to-date visibility mode of the other user.

In general, elements may be “enabled to be activated” at least in that they may be displayed to a user, selectable by a user, displayed to a user in a manner that indicates their enabled activation, permitted to a user (e.g., as an operation performed by the user), set as a response to a user operation, provided to a client device, or otherwise allowed to be experienced by a user or interact with a user, as described in particular examples throughout this disclosure.

In some implementations, some or all features associated with progressive visibility modes are paid features of the social network, e.g., as a premium function. In one example, a user is locked into a particular visibility mode (e.g., fully visible mode) in the absence of payment. In another example, a user may select between default visibility modes even in the absence of payment, but cannot customize those visibility modes or create their own customized visibility modes in the absence of payment. Other features described herein may additionally or instead be locked behind social network payment.

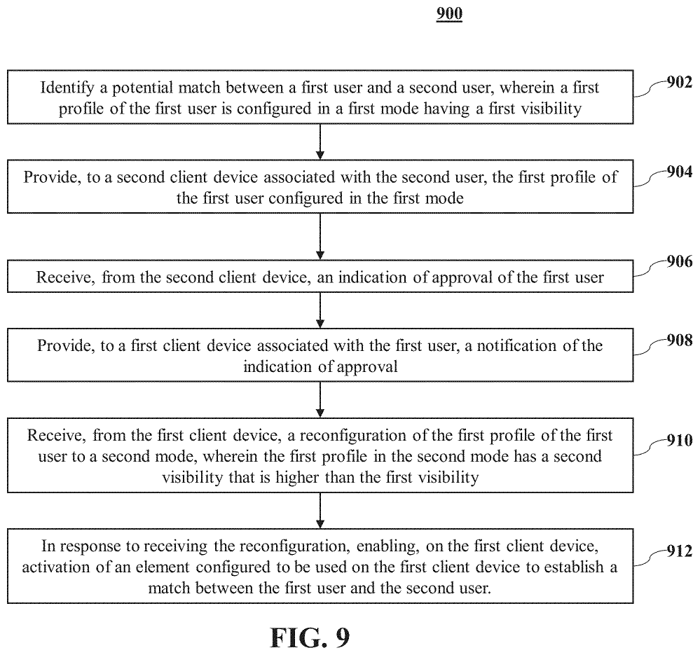

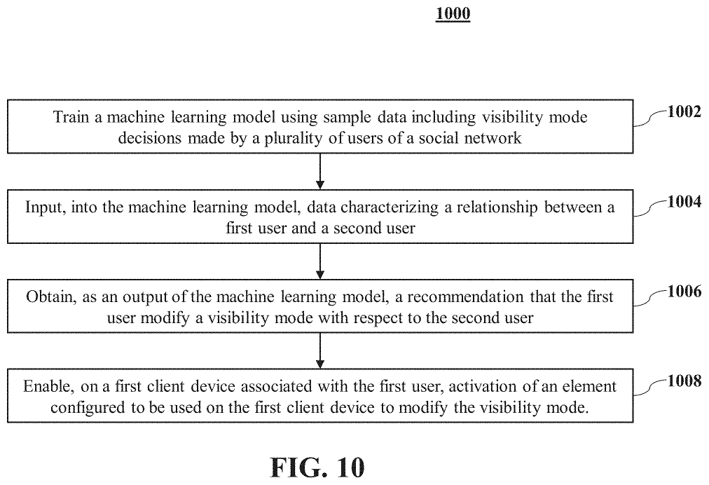

FIGS. 9-10 show example processes 900, 1000. These processes 900, 1000, and various other processes described in this disclosure, can be performed by any of the computer systems described in this disclosure or by combinations of them, such as by server 204, one or more client devices 202, or by these systems in combination.

In the example process 900, a potential match is identified between a first user and a second user (902). A first profile of the first user is configured in a first mode having a first visibility. The first profile of the first user, configured in the first mode, is provided to a second client device associated with the second user (904). An indication of approval of the first user is received from the second client device (906). A notification of the indication of approval is provided to a first client device associated with the first user (908). A reconfiguration of the first profile of the first user to a second mode is received from the first client device (910). The first profile in the second mode has a second visibility that is higher than the first visibility. In response to receiving the reconfiguration, activation of an element is enabled on the first client device (912). The element is configured to be used on the first client device to establish a match between the first user and the second user.

In the example process 1000, a machine learning model is trained using sample data including visibility mode decisions made by a plurality of users of a social network (1002). Data characterizing a relationship between a first user and a second user is input into the machine learning model (1004). As an output of the machine learning model, a recommendation is obtained that the first user modify a visibility mode with respect to the second user (1006). On a first client device associated with the first user, activation of an element is enabled (1008). The element is configured to be used on the first client device to modify the visibility mode.

Various implementations of the systems and techniques described here, such as servers and client devices, can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable processing system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” or “computer-readable medium” refer to any computer program product, apparatus and/or device (e.g., magnetic discs, optical disks, memory, Programmable Logic Devices (PLDs)) used to provide machine instructions and/or data to one or more programmable processors, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well. For example, feedback provided to the user can be any form of sensory feedback (e.g., visual feedback, auditory feedback, or tactile feedback). Input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by the data processing apparatus, cause the apparatus to perform the operations or actions.

Although a few implementations have been described in detail above, other modifications are possible. Logic flows depicted in the figures do not require the particular order shown, or sequential order, to achieve desirable results. In addition, other actions may be provided, or actions may be eliminated, from the described flows, and other components may be added to, or removed from, the described systems. Disclosed user interfaces and user interaction methods are examples; other user interfaces and interaction methods may additionally or alternatively be used. Accordingly, other implementations are within the scope of the following claims.

What is claimed is:

1. A computer-implemented method comprising:
identifying a potential match between a first user and a second user, wherein a first profile of the first user is configured in a first mode having a first visibility;
providing, to a second client device associated with the second user, the first profile of the first user configured in the first mode;
receiving, from the second client device, an indication of approval of the first user;
providing, to a first client device associated with the first user, a notification of the indication of approval;
receiving, from the first client device, a reconfiguration of the first profile of the first user to a second mode, wherein the first profile in the second mode has a second visibility that is higher than the first visibility; and
in response to receiving the reconfiguration, enabling, on the first client device, activation of an element configured to be used on the first client device to establish a match between the first user and the second user.

2. The computer-implemented method of claim 1, wherein enabling activation of the element comprises:
querying a database storing a plurality of elements, wherein each element of the plurality of elements is associated with one or more visibility modes, wherein the querying includes selecting, from the plurality of elements, a subset of elements that are associated with the second mode, and wherein the subset of elements includes the element.

3. The computer-implemented method of claim 2, wherein the element is associated with the second mode and not associated with the first mode.

4. The computer-implemented method of claim 1, wherein the element comprises at least one of a user interface element or a response to a user input trigger.

5. The computer-implemented method of claim 1, comprising preventing establishment of the match between the first user and the second user until the first profile is reconfigured from the first mode to the second mode or to another mode with a higher visibility than the first mode.

6. The computer-implemented method of claim 1, wherein the reconfiguration of the first profile to the second mode is with respect to the second user, and wherein the method further comprises:
subsequent to receiving the reconfiguration of the first profile to the second mode, providing, to a third user-device associated with a third user, the first profile of the first user configured in the first mode.

7. The computer-implemented method of claim 1, wherein the reconfiguration of the first profile to the second mode is a global reconfiguration, and wherein the method further comprises:
subsequent to receiving the reconfiguration of the first profile to the second mode, providing, to a third user-device associated with a third user, the first profile of the first user configured in the second mode.

8. The computer-implemented method of claim 1, comprising, prior to receiving the indication of approval of the first user:
receiving, from the second client device, a reconfiguration of a second profile of the second user to have an increased visibility; and
in response to receiving the reconfiguration of the second profile of the second user, providing, to the second client device, a user-interactive interface configured to be used to provide the indication of approval of the first user.

9. The computer-implemented method of claim 8, comprising preventing provision of the indication of approval of the first user until the second profile is reconfigured to have the increased visibility.

10. The computer-implemented method of claim 1, comprising:
receiving, from the first client device, a second reconfiguration of the first profile of the first user from the second mode to a third mode, wherein the first profile in the third mode has a third visibility that is higher than the second visibility.

11. The computer-implemented method of claim 1, wherein the second visibility is higher than the first visibility with respect to photo blurring or video blurring of one or more elements of the first profile.

12. The computer-implemented method of claim 1, wherein the second visibility is higher than the first visibility with respect to audio distortion of one or more elements of the first profile.

13. The computer-implemented method of claim 1, wherein the second visibility is higher than the first visibility with respect to private information of the first user.

14. The computer-implemented method of claim 1, wherein receiving the reconfiguration of the first profile comprises receiving an indication of a tap-and-hold on the first client device.

15. The computer-implemented method of claim 1, comprising:
determining, based on a configuration of the second mode, a first media communication type that is allowed in the second mode, and a second media communication type that is disallowed in the second mode; and
providing, to the second client device, a communication interface comprising a first interface element configured to be used to transmit a message of the first media communication type, the communication interface excluding a second interface element configured to be used to transmit a message of the second media communication type.

16. The computer-implemented method of claim 1, wherein providing the first profile of the first user configured in the first mode comprises:
obtaining an image included in the first profile or a video frame included in the first profile;
blurring the image or the video frame, to obtain a blurred image or a blurred video frame; and
providing the blurred image or the blurred video frame.

17. The computer-implemented method of claim 1, wherein a livestream associated with the first user is not visible to the second user when the first profile is configured in the first mode, and wherein the livestream is visible to the second user when the first profile is configured in the second mode.

18. One or more tangible, non-transitory, computer-readable media storing instructions that, when executed by a processing system, cause the processing system to perform operations comprising:
identifying a potential match between a first user and a second user, wherein a first profile of the first user is configured in a first mode having a first visibility;
providing, to a second client device associated with the second user, the first profile of the first user configured in the first mode;
receiving, from the second client device, an indication of approval of the first user;
providing, to a first client device associated with the first user, a notification of the indication of approval;
receiving, from the first client device, a reconfiguration of the first profile of the first user to a second mode, wherein the first profile in the second mode has a second visibility that is higher than the first visibility; and
in response to receiving the reconfiguration, enabling, on the first client device, activation of an element configured to be used on the first client device to establish a match between the first user and the second user.

19. The computer-readable media of claim 18, wherein the operations comprise:
determining, based on a configuration of the second mode, a first media communication type that is allowed in the second mode, and a second media communication type that is disallowed in the second mode; and
providing, to the second client device, a communication interface comprising a first interface element configured to be used to transmit a message of the first media communication type, the communication interface excluding a second interface element configured to be used to transmit a message of the second media communication type.

20. A computer-implemented system, comprising:
one or more computers; and
one or more computer memory devices interoperably coupled with the one or more computers and having tangible, non-transitory, machine-readable media storing one or more instructions that, when executed by the one or more computers, cause the one or more computers to perform operations comprising:
identifying a potential match between a first user and a second user, wherein a first profile of the first user is configured in a first mode having a first visibility;
providing, to a second client device associated with the second user, the first profile of the first user configured in the first mode;
receiving, from the second client device, an indication of approval of the first user;
providing, to a first client device associated with the first user, a notification of the indication of approval;
receiving, from the first client device, a reconfiguration of the first profile of the first user to a second mode, wherein the first profile in the second mode has a second visibility that is higher than the first visibility; and
in response to receiving the reconfiguration, enabling, on the first client device, activation of an element configured to be used on the first client device to establish a match between the first user and the second user.

21. The computer-implemented system of claim 20, wherein the operations comprise:
determining, based on a configuration of the second mode, a first media communication type that is allowed in the second mode, and a second media communication type that is disallowed in the second mode; and
providing, to the second client device, a communication interface comprising a first interface element configured to be used to transmit a message of the first media communication type, the communication interface excluding a second interface element configured to be used to transmit a message of the second media communication type.

22. A computer-implemented method comprising:
training a machine learning model using sample data comprising visibility mode decisions made by a plurality of users of a social network;
inputting, into the machine learning model, data characterizing a relationship between a first user and a second user;
obtaining, as an output of the machine learning model, a recommendation that the first user modify a visibility mode with respect to the second user; and
enabling, on a first client device associated with the first user, activation of an element configured to be used on the first client device to modify the visibility mode.

23. The computer-implemented method of claim 22, wherein training the machine learning model comprises training a neural network that comprises connected nodes, wherein the connected nodes are aggregated into multiple layers, and wherein the connected nodes perform successive transformations of input data.

24. The computer-implemented method of claim 22, wherein the sample data comprises one or more of: past negative interactions between the plurality of users, lengths of past relationships of the plurality of users, and results of the past relationships of the plurality of users.

25. The computer-implemented method of claim 22, wherein training the machine learning model comprises weighting sample data associated with the first user more highly than sample data associated with other users of the plurality of users.

26. The computer-implemented method of claim 22, wherein the data characterizing the relationship comprises one or more of: one or more types of interactions between the first user and the second user; a quality of the interactions between the first user and the second user; interest in the relationship from the first user, the second user, or both the first user and the second user; or a length of the relationship.
